(19) United States
(12) Patent Application Publication
(10) Pub. No.: US 2024/0410542 A1
(43) Pub. Date: Dec. 12, 2024

(54) LIGHTING DEVICE FOR VEHICLE

(71) Applicant: Seong Geun SON, Daegu (KR)

(72) Inventor: Seong Geun SON, Daegu (KR)

(21) Appl. No.: 18/811,680

(22) Filed: Aug. 21, 2024

Related U.S. Application Data
(63) Continuation of application No. PCT/IB2023/052150, filed on Mar. 7, 2023.

(30) Foreign Application Priority Data
Mar. 7, 2022 (KR) 10-2022-0028871
Mar. 7, 2023 (KR) 10-2023-0030249

(51) Int. Cl. F21S 41/25; F21S 41/143; F21S 41/32

(52) U.S. Cl. CPC F21S 41/25; F21S 41/143; F21S 41/32

(57) ABSTRACT

Proposed is a lighting device for a vehicle, including a light source and a cut-off refractive lens disposed in front of the light source, the lighting device for a vehicle characterized in that the cut-off refractive lens includes an entry surface and an exit surface, and realizes a set light distribution of a symmetrical or asymmetrical beam, one or more cut-off refractive lens sections are formed continuously, and one or more cut-off refractive lens sections are formed on at least one of a vertical extrusion section of an internal ray and a vertical section independent of a propagation path of the internal ray, the cut-off refractive lens sections refract, at the exit surface, internal rays transmitted through an entry surface curve so as to satisfy a set upper and lower light distribution.

### CROSS REFERENCE TO RELATED APPLICATION

This application is a continuation application of co-pending PCT International Application No. PCT/IB2023/052150, filed Mar. 7, 2023, the disclosure of which is incorporated herein by reference.

### TECHNICAL FIELD

The present disclosure relates to a lighting device for a vehicle and, more particularly, to a lighting device for a vehicle used for lighting to secure the driver's field of vision, such as headlights and fog lights mounted on vehicles such as cars, motorcycles, trains, and bicycles.

### BACKGROUND ART

Since each country regulates the installation location, light distribution, and color of light for vehicle lighting devices by law, a vehicle lighting device that is efficient and meets these regulatory standards is needed. When using a projection-type optical structure to manufacture automobile headlights and fog lights in small sizes among vehicle lighting devices, not only about 50% of the light is lost, but also color separation occurs at the cut-off line. Although research on this is ongoing, the problem has not been completely resolved.

An automotive lighting device to solve the above problem is disclosed in the applicant's Korean Patent Publication No. 10-2419832, in which an auxiliary reflector and an auxiliary lens part are used in order to realize the cut-off line without color separation in a cut-off refractive lens by receiving parallel light emitted by a condenser lens that condenses light from a light source into parallel light, and to utilize lateral light of the light source.

### Documents of Related Art

1. Korean Patent Application Publication No. 10-2019-0081690
(Invention Title: LAMP FOR VEHICLE)
2. Japanese Patent No. H07-118204B2 (Invention Title: HEADLIGHT FOR DIMMING LAMP OR FOG LAMP OF AUTOMOBILE)
3. Japanese Patent Application Publication No. 2002-358806
(Invention Title: HEAD LAMP)

### DISCLOSURE

### Technical Problem

A projection-type optical structure mainly used in passing beam headlights, a representative vehicle lighting device, does not solve the problem of color separation occurring at the cut-off line, and requires the use of a shield, resulting in light loss of approximately 50% or more. Moreover, there are disadvantages such as low luminous efficiency, high energy consumption, and increased weight and volume of a heat sink, but these problems were solved in the above-mentioned U.S. Pat. No. 2,419,832.

Meanwhile, since the aforementioned patent No. 2419832 employs an auxiliary reflector and an auxiliary lens part to efficiently utilize the light from a light source, it is necessary to reduce the number of parts when considering assembly tolerances and costs, etc. In particular, there is a need to provide a vehicle lighting device with reduced number of lenses that require precision processing by integrating the function of a thick condenser lens, which condenses parallel light from the up and down direction, into a cut-off refractive lens, and a vehicle lighting device that realizes both symmetrical and asymmetrical beams with only one cut-off refractive lens.

However, patent No. 2419832 failed to suggest a method of producing a headlamp that realizes an asymmetric beam using only a cut-off refractive lens, and only a method of realizing an asymmetric beam by using a reinforcement lens in the auxiliary lens part was disclosed. Therefore, a method is needed to achieve not only a symmetric beam but also an asymmetric beam with cut-off line upward to the left or right in a cut-off refractive lens.

In addition, since patent No. 2419832 uses a lens that condenses parallel light when viewed from the side, light with strong color separation reaches the top and bottom of a cut-off refractive lens, and to eliminate color separation at the maximum downward angle, upper and lower exit lights had to be combined. For cases where color separation is not resolved, Patent No. 2419832 proposes a method of overlapping with scattered light emitted from the auxiliary lens part or light refracted at the maximum downward angle by the reinforcement lens of the auxiliary lens. Therefore, a method in which no significant color separation occurs from the beginning in the vertical direction when viewed from the side until the maximum downward angle is reached is needed.

In addition, to realize left-right asymmetric light distribution of an asymmetric beam, it is necessary to efficiently distribute the amount of light in the left and right direction, but Patent No. 2419832 failed to provide a device that efficiently distributes the light from the light source in the left-right or up-down direction from the beginning, which is the reason why the auxiliary lens part was mainly used.

### Technical Solution

In order to solve the above mentioned problems, according to an aspect of the present disclosure, there is provided a lighting device for a vehicle, the device including: a light source; and a cut-off refractive lens, wherein the cut-off refractive lens may be configured to include an entry surface that receives light and an exit surface that refracts internal rays that have passed through the entry surface and emits the refracted internal rays, and to realize a set light distribution of a symmetrical or asymmetrical beam, the cut-off refractive lens may be constructed by continuously forming one or more cut-off refractive lens sections in a vertical direction, and the one or more cut-off refractive lens sections may be formed on at least one of a section created by continuing a propagation path of an internal ray on a horizontal plane, which passes through the entry surface and is refracted at the exit surface, in the vertical direction, and a vertical section independent of the propagation path of the internal ray, any cut-off refractive lens section, among the one or more cut-off refractive lens sections, formed on the vertical section independent of the propagation path of the internal ray may be moved and placed at a predetermined position on a continuous surface forming the cut-off refractive lens in order to realize light exiting at a predetermined left and right angle from the cut-off refractive lens, each of the one or more cut-off refractive lens sections may include an entry surface curve that is an intersection with the entry surface and an exit surface curve that is an intersection with the exit surface, the one or more cut-off refractive lens sections may satisfy a set vertical light distribution by refracting internal rays that transmitted through the entry surface curve at the exit surface, the entry surface curve of the each of the one or more cut-off refractive lens sections may be formed so that the internal rays transmitted through the entry surface curve are not totally internally reflected on the exit surface, and the individual internal rays do not upwardly and downwardly cross adjacent internal rays or converge at a point on the exit surface, and in order to form a predetermined left and right light distribution of exit light of the cut-off refractive lens, a continuous surface may be formed by gradually moving forward or backward, so as to make continuous, each curve of any one or more among the entry surface curves and exit surface curves at a predetermined cut-off refractive lens section and a continuous adjacent cut-off refractive lens section among the one or more cut-off refractive lens sections on the continuous surface forming the cut-off refractive lens.

In this case, a left and right angle of the internal ray may be changed in a horizontal section of the cut-off refractive lens by adjusting a left-right incident angle of incident light by gradually moving forward or backward, so as to make continuous, the entry surface curve of a cut-off refractive lens section and an adjacent cut-off refractive lens section among the one or more cut-off refractive lens sections.

In addition, a predetermined left and right direction of light exiting from the cut-off refractive lens sections may be formed by gradually moving forward or backward, so as to make continuous, the exit surface curve of a cut-off refractive lens section and an adjacent cut-off refractive lens section among the one or more cut-off refractive lens sections.

In one example, the lighting device may further include a condenser lens disposed between the light source and the cut-off refractive lens, and configured to distribute light emitted from the light source symmetrically or asymmetrically in a left-right direction or up-down-left-right direction to emit the light in a direction of the cut-off refractive lens.

In this case, in a portion of the condenser lens, a luminous flux reduction zone where light is emitted with reduced luminous flux may be included.

In addition, the condenser lens may be a separate configuration from the light source, or may be formed on a front side of the light source as part of the light source, and be either integrally formed inseparably with the light source or mounted to be separable from the light source.

In another example, each of the cut-off refractive lens sections may be subdivided into one or more sub-regions, and a predetermined vertical light distribution may be assigned to each sub-region.

In this case, one or more corners may be formed on the exit surface of the cut-off refractive lens by continuing the exit surface curves of the cut-off refractive lens sections formed so that one or more sub-regions and other sub-regions adjacent thereto may emit light at different vertical angles from contact points.

In addition, naturally continuous sub-regions may be formed on the exit surface of the cut-off refractive lens by continuing the exit surface curves of the cut-off refractive lens sections, which are formed as a naturally continuous curve so that any one sub-region and another sub-region adjacent thereto may emit light at a same vertical angle from a contact point.

In addition, in one example, vertical light distribution of the one or more cut-off refractive lens sections constituting the cut-off refractive lens may form cutoff that varies light and dark at a predetermined vertical angle without a shield, and the cut-off refractive lens constructed by continuing the cut-off refractive lens sections may realize a cut-off line.

In this case, a cut-off angle conversion zone, in which the vertical light distribution of the cut-off refractive lens sections is formed to gradually vary up and down cut-off angles so that the cut-off angles gradually change in part of a continuous section of the cut-off refractive lens sections, may be formed in the cut-off refractive lens.

In addition, in order to prevent or minimize color separation at the cut-off line, the cut-off refractive lens may focus light from an optical axis or a center close to the optical axis of the light source to a bright area of the cut-off line.

Furthermore, in order to prevent color separation from occurring at a maximum downward angle of a set vertical light distribution, light exiting from the light source at a same angle as the maximum downward angle may be emitted from the cut-off refractive lens at a set maximum downward angle.

In addition, light may be emitted at a maximum downward angle of a set vertical light distribution at a specific point on a vertical section of an upper part of the exit surface of the cut-off refractive lens, and light may be emitted at the maximum downward angle at a specific point on a vertical section of a lower part of the exit surface, wherein the light emitted from the specific point on the upper part of the exit surface may be separated into red above and blue below, with yellow as a center, and the light emitted from the specific point on the lower part of the exit surface may be separated into blue above and red below, with yellow as a center, and since color separation widths of the lights emitted from the respective specific points on the upper and lower parts of the exit surface are similar to each other, color separation may be eliminated.

Furthermore, by disposing the condenser lens between the light source and the cut-off refractive lens, light exiting from the light source may be distributed symmetrically or asymmetrically in the up-down-left-right direction, and emitted in a direction of the cut-off refractive lens, or by additionally placing a vertical refractive lens between the light source and the cut-off refractive lens, the light exiting from the light source may be emitted as parallel light or close to the parallel light when viewed from a side.

In this case, the lighting device may further include: a reflector configured to reflect light deviating from the condenser lens or a vertical refractive lens into parallel light or close to the parallel light when viewed from a side as the condenser lens or the vertical refractive lens moves away from the light source; and one or more auxiliary lenses formed on an outside of the cut-off refractive lens, or on an outside of the condenser lens or the vertical refractive lens, configured to refract, diffuse, or refract and diffuse the light reflected from the reflector in a set direction.

### Advantageous Effects

According to an embodiment of the present disclosure, it is possible to solve the problem of color separation at the cut-off line, which is a chronic problem with conventional projection-type vehicle lighting devices, and to utilize most of the light from a light source since there is no loss of light caused by using a shield.

As an embodiment, assuming a cut-off refractive lens whose distance from the light source is ½ of the top and bottom width, by simply placing a condenser lens that refracts weakly in the left and right direction on a plane at a close distance from a light source or attaching such condenser lens to the light source, when unilateral diffused light in the left and right direction with a width of about 60 degrees in a plane is condensed from the light source to a width of 45 degrees and emitted to the cut-off refractive lens, approximately 79% ((87% (unilateral 60 degree width of light left and right →condensed to 45 degrees)+71% (45 degree width of light up and down is transmitted as is))/2) of the light can be utilized, while a sharp cut-off line can be realized.

Furthermore, in cases where light efficiency is not important, according to an embodiment, even if the condenser lens is removed, approximately 71% of the light can be utilized as the cut-off refractive lens is irradiated with a unilateral 45 degree width of light, and thus even if 8% light loss occurs due to no anti-reflection coating on the cut-off refractive lens, excellent luminous efficiency of approximately 66% (71*(1−0.08)) can be achieved, boasting excellent light efficiency compared to conventional projection headlights that use a shield.

Furthermore, according to the present disclosure, a lens that condenses parallel light when viewed from the side may not be used, only a weak condensation intensity may be used, or a condenser lens that condenses parallel light on the upper side thereof but does not condense parallel light on the lower side thereof may be used. Thus, in the vertical direction, the light rays of the maximum downward angle (e.g., an arbitrary setting angle of about D4° to D15°) from a light source in which color separation does not occur from the beginning, can be emitted at the maximum downward angle through a cut-off refractive lens, while a sharp cut-off line can be created by focusing the light without color separation of an optical axis on the cut-off line, thereby eliminating the problem of color separation. There is also no color separation problem in the left and right direction since the diffused light from the light source is diffused to the left and right in a similar width.

Furthermore, it is possible to provide a vehicle lighting device that can reduce side effects according to the principle of image in a cut-off angle conversion zone and facilitate processing as the condenser lens collects light when viewed from a plane but includes a luminous flux reduction zone, and by making the luminous flux reduction zone correspond to a cut-off angle conversion zone of the cut-off refractive lens, and emitting light with luminous flux reduced in the luminous flux reduction zone.

The effects according to an embodiment solve the problems of color separation and light loss, which are chronic problems of the conventional projection-type vehicle lighting devices, and it is possible to provide an efficient vehicle lighting device without color separation while realizing a sharp cut-off line in an overall smaller size without a reflector or an auxiliary lens part compared to U.S. Pat. No. 2,419,832.

It is obvious that various characteristic effects can be derived from the features of the various embodiments and modifications of the present disclosure within the scope of understanding of those skilled in the art even if the effects are not directly mentioned in the specification of the present disclosure.

### DESCRIPTION OF DRAWINGS

FIG. 1a is a view showing the overall appearance of a lighting device for a vehicle according to an embodiment of the present disclosure.

FIG. 1b is a view showing light distribution of FIG. 1a.

FIG. 1c is an optical characteristic curve (Iv) along the center line of FIG. 1b.

FIG. 2a is a view showing the overall appearance of a lighting device for a vehicle according to another embodiment of the present disclosure, and shows a correction of the tilt of an exit portion in the cut-off line direction on a left exit surface compared to FIG. 1a.

FIG. 2b is a view showing light distribution of FIG. 2a.

FIG. 2c is an optical characteristic curve (Iv) along the center line of FIG. 2b.

FIG. 3a is a view schematically showing a cut-off refractive lens section formed along an internal light path in the lighting device for a vehicle according to another embodiment of the present disclosure.

FIG. 3b is a plan view of FIG. 3a showing the path of an internal ray in the cut-off refractive lens.

FIG. 4 is a view showing an optical path in which a condenser lens adjusts light distribution asymmetrically left and right in a plane in the lighting device for a vehicle according to another embodiment of the present disclosure.

FIG. 5 is a view showing multiple sub-regions emit light with different vertical light distributions in a section of the cut-off refractive lens in the lighting device for a vehicle according to another embodiment of the present disclosure.

FIG. 6 is an optical path in which the left and right light amounts are adjusted from an entry surface of the cut-off refractive lens and distributed to an exit surface of the cut-off refractive lens in the lighting device for a vehicle according to another embodiment of the present disclosure.

FIG. 7 is a view schematically showing a vertical section of the cut-off refractive lens in the lighting device for a vehicle according to another embodiment of the present disclosure.

FIG. 8 is a view showing cross-exiting of light rays in a section of the cut-off refractive lens in the lighting device for a vehicle according to another embodiment of the present disclosure.

### BEST MODE

The present disclosure relates to a lighting device for a vehicle and according to an embodiment, a lighting device for a vehicle includes a light source and a cut-off refractive lens 30 disposed in front of the light source, the lighting device for a vehicle characterized in that: the cut-off refractive lens 30 is configured to include an entry surface 30a that receives light and an exit surface 30b that refracts internal rays that have passed through the entry surface and emits the refracted internal rays, and to realize a set light distribution of a symmetrical or asymmetrical beam; the cut-off refractive lens 30 is constructed as one or more cut-off refractive lens sections 31 formed in the vertical direction are continuing, and one or more cut-off refractive lens sections 31 are formed on at least one of a section created by continuing a propagation path of an internal ray on the horizontal plane, which passes through the entry surface 30a and is refracted at the exit surface 30b, in the vertical direction, and a vertical section independent of the propagation path of the internal ray; the cut-off refractive lens section 31 formed on the vertical section independent of the propagation path of the internal ray is moved and placed at a predetermined position on a continuous surface forming the cut-off refractive lens 30 in order to realize light exiting at a predetermined left and right angle from the cut-off refractive lens 30; the cut-off refractive lens section 31 includes an entry surface curve 31a that is an intersection with the entry surface 30a and an exit surface curve 31b that is an intersection with the exit surface 30b; the cut-off refractive lens sections 31 satisfy a set vertical light distribution by refracting internal rays that transmitted through the entry surface curve 31a at the exit surface 30b; the entry surface curve 31a is formed so that the internal rays transmitted through the entry surface curve 31a are not totally internally reflected on the exit surface 30b, and the individual internal rays do not upwardly and downwardly cross adjacent internal rays or converge at a point on the exit surface 30b; and in order to form a predetermined left and right light distribution of exit light of the cut-off refractive lens 30, a continuous surface is formed by gradually moving forward or backward, so as to make continuous, each curve of any one or more among the entry surface curves 31a and exit surface curves 31b at a predetermined cut-off refractive lens section 31 and a continuous adjacent cut-off refractive lens section 31 on the continuous surface forming the cut-off refractive lens 30.

### MODE FOR INVENTION

Embodiments of the present disclosure for achieving the above-described objectives will be described with reference to the attached drawings. The disclosure in this specification and/or drawings is not intended to be limited to specific embodiments of the disclosed technology, but should be understood to include various modifications, equivalents, and/or substitutes for the disclosed embodiments. In the description of this specification, additional descriptions may be omitted to facilitate understanding of the present disclosure by those skilled in the art.

In addition, since the terms used in this specification are only used to describe specific embodiments, they should not be construed as limiting the scope of other embodiments unless explicitly stated. For example, it should be noted that a singular expression may be used as a concept representing a plurality of elements as a whole.

The drawings referenced herein are examples for explaining embodiments of the present disclosure, and shape, size and/or thickness, etc. may be exaggerated or understated for effective explanation of technical features.

In this specification, a vehicle refers to any vehicle running on a road or track, such as a car, a motorcycle, a train, or a bicycle. Therefore, there is no need to limit the interpretation of the present disclosure to only an automotive lighting device. For example, the same method may be applied to lighting devices such as work lights without forming a cut-off line using the cut-off refractive lens of the present disclosure.

It should be understood that, in this specification, the explanation is based on the assumption that an optical axis of a lighting device for a vehicle is aligned with a H-V center for convenience of understanding, and in practice, the optical axis may be arbitrarily modified to deviate from the H-V center. It should also be understood that the point that “aiming” needs to be performed according to regulations when measuring a manufactured lighting device for a vehicle is excluded from the discussion.

In this specification, “measuring screen” refers to a flat vertical screen set up at a distance of 10 or 25 m in front of a lighting device for a vehicle when measuring the lighting device for a vehicle according to the regulations of each country, and is known to experts in this field.

In this specification, a front refers to the direction of the measuring screen, a horizontal plane refers to an extrusion plane of a H line (horizontal line) of the measuring screen, that is, the surface formed by the H line continuing forward and backward, a plane refers to the surface parallel to the horizontal plane, a vertical plane refers to an extrusion plane of a V line (vertical line), that is, the surface formed by the V line continuing forward and backward, and a side refers to the surface parallel to the vertical plane.

In this specification, the upper part of a cut-off refractive lens points above the horizontal plane, assuming that an optical axis is aligned with the horizontal plane, and the lower part of the cut-off refractive lens points below the horizontal plane.

In this specification, “up and down direction” refers to the direction of the up (or U) and down (or D) angles on the measuring screen, and “left and right direction” refers to the direction of the left (or L) and right (or R) angles of the measuring screen.

In this specification, “extrude” means creating a surface or solid that extends the shape of a curve (line), and “sweep” means creating a curved surface or solid from a section curve positioned along a path. Thus, an extrusion plane refers to a flat surface formed by extruding a straight line.

In this specification, all ray paths assume an ideal point light source, and it should be understood that various problems arising due to the area or volume of the light source, that is, the size of an image, needs to be considered.

It should be understood that in this specification, “an internal ray formed on the horizontal plane of the cut-off refractive lens” refers to an internal ray formed in the process of realizing left and right light distribution in 2D before forming a 3D shape, and an internal ray in the 3D cut-off refractive lens completed by the method described herein may be inconsistent with the horizontal plane and be tilted in a predetermined vertical direction. Similarly, “an internal ray formed in the section of the cut-off refractive lens” refers to “an internal ray formed in the process of realizing the vertical light distribution of the cut-off refractive lens in 2D before forming a 3D shape, and an internal ray in the 3D cut-off refractive lens completed by the method described herein may be further refracted left and right or up and down inconsistent with the vertical extrusion plane, that is, a surface formed by continuing the internal rays formed on the horizontal plane of the cut-off refractive lens in the vertical direction. In addition, when internal rays from the completed 3D are projected onto the 2D plane, minor discrepancies may occur.

Nevertheless, it should be taken into account that the computer simulated light distribution of the 3D cut-off refractive lens created in this way realizes a satisfactory light distribution in accordance with the purpose of the present disclosure.

In this specification, since the cut-off line angle or maximum downward irradiation angle may be arbitrarily determined within the range permitted by each country's laws, and is therefore not used in a sense limited to the angles exemplified in the specification.

On the premise of the above description, a lighting device for a vehicle according to an example of the present disclosure will be examined with reference to the drawings. When explaining with reference to the drawings, drawing numbers not described in the corresponding drawings may be drawing numbers indicating the same configuration in other drawings.

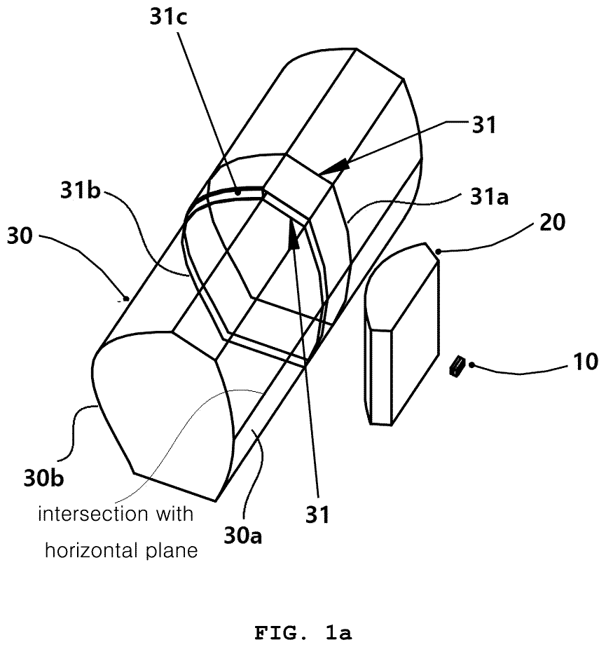

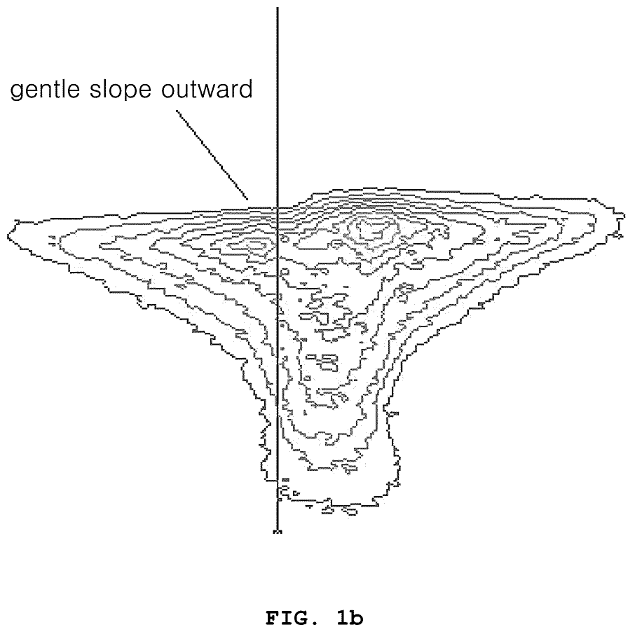

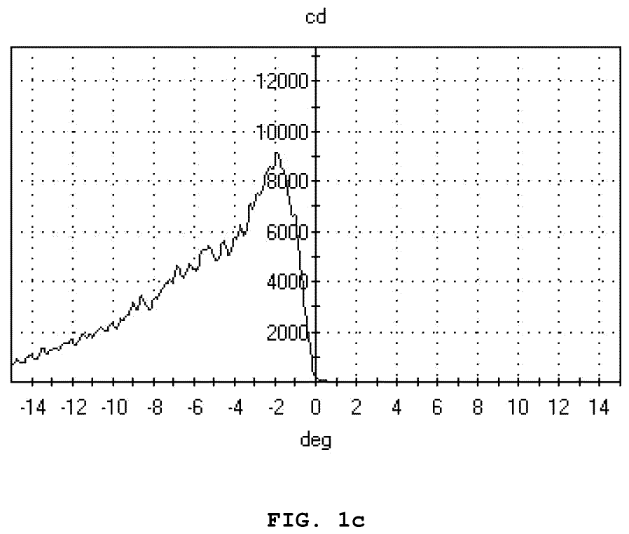

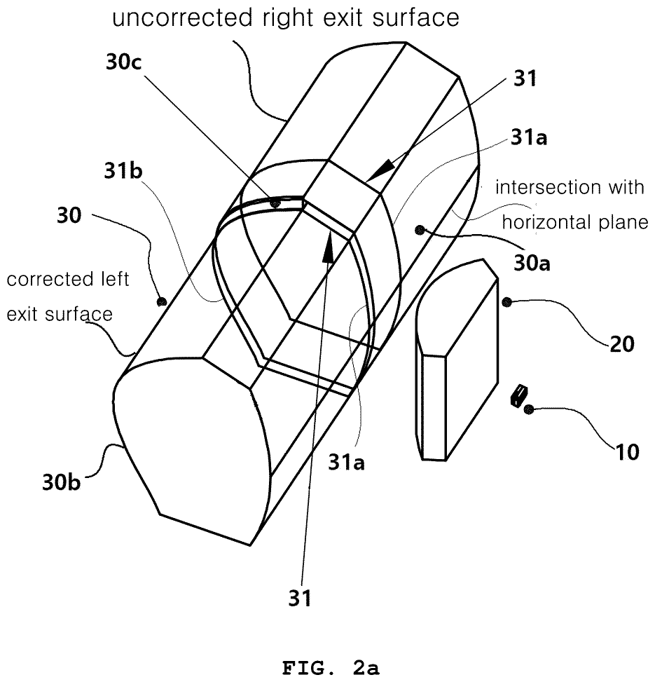

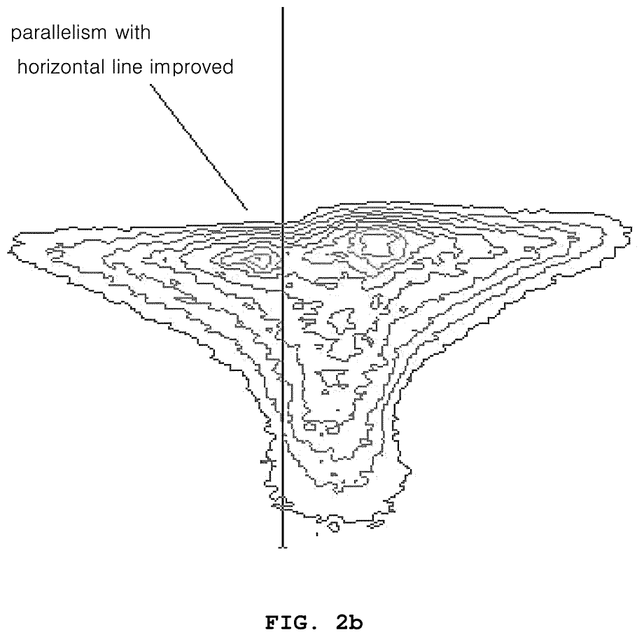

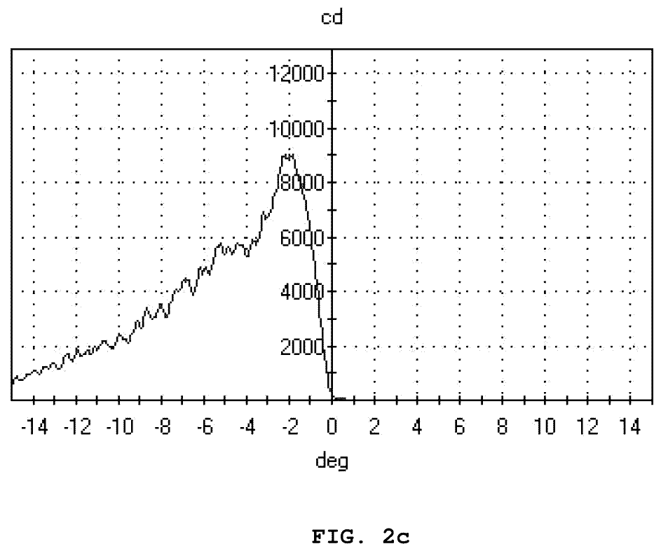

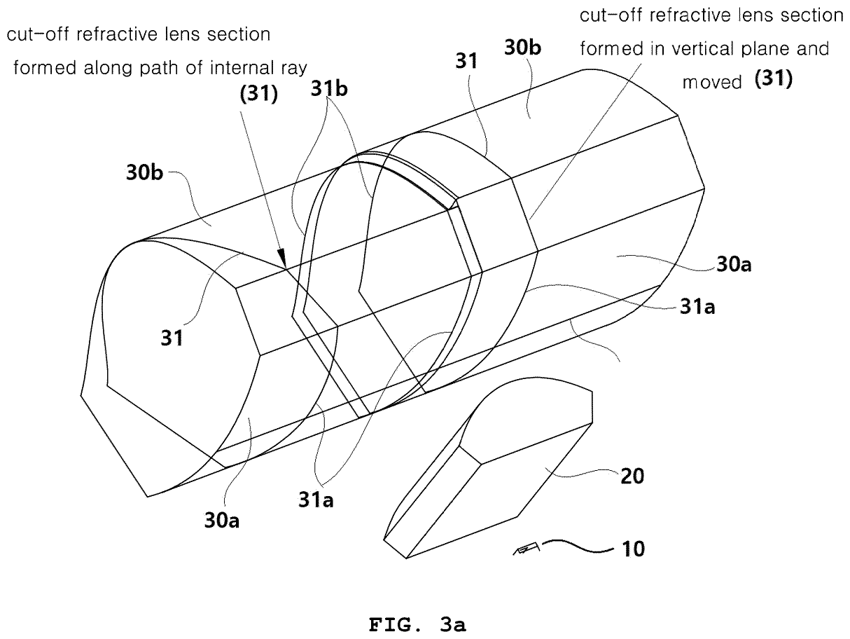

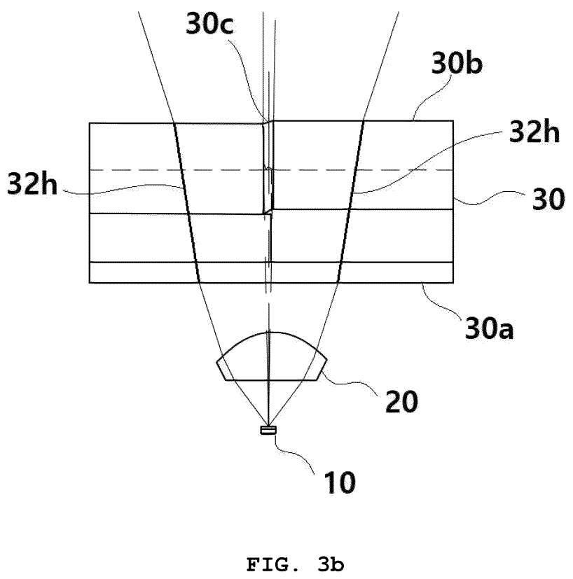

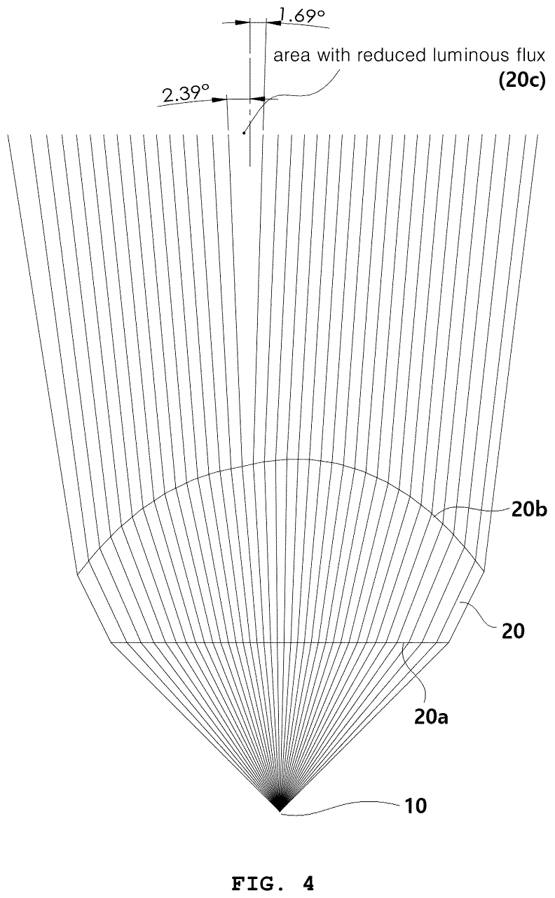

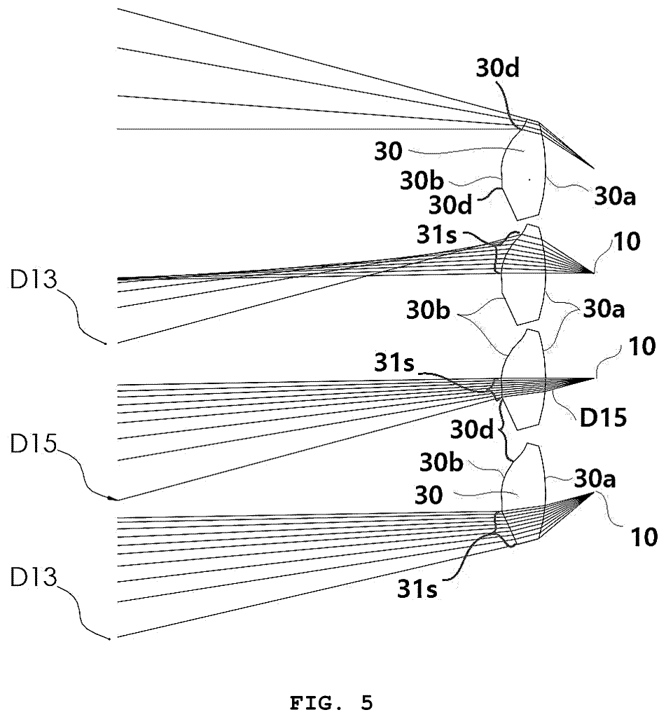

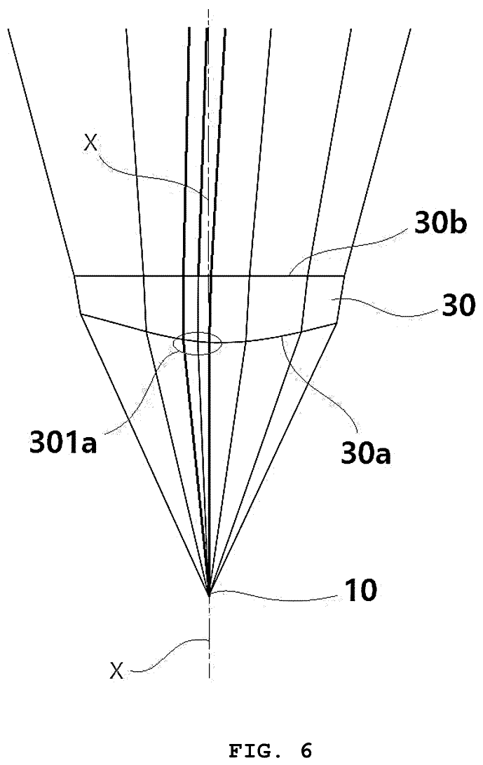

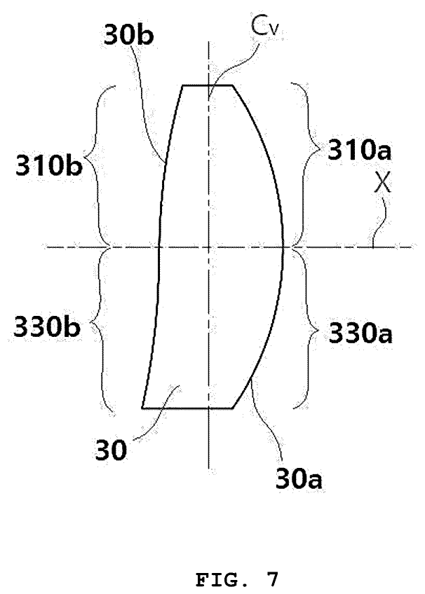

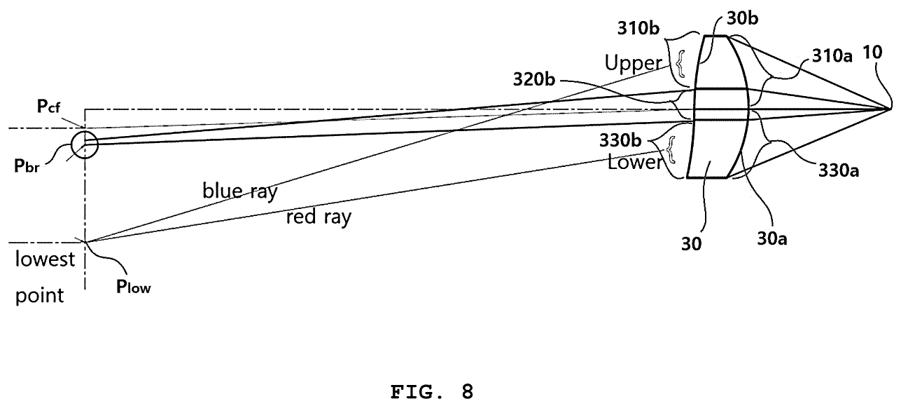

FIG. 1a is a view showing the overall appearance of a lighting device for a vehicle according to an embodiment of the present disclosure, FIG. 1b is a view showing light distribution of FIG. 1a, and FIG. 1c is an optical characteristic curve (Iv) along the center line of FIG. 1b. FIG. 2a is a view showing the overall appearance of a lighting device for a vehicle according to another embodiment of the present disclosure, and shows a correction of the tilt of an exit portion in the cut-off line direction on a left exit surface compared to FIG. 1a, FIG. 2b is a view showing light distribution of FIG. 2a, and FIG. 2c is an optical characteristic curve (Iv) along the center line of FIG. 2b. FIG. 3a is a view schematically showing a cut-off refractive lens section formed along an internal light path in the lighting device for a vehicle according to another embodiment of the present disclosure, and FIG. 3b is a plan view of FIG. 3a showing the path of an internal ray in the cut-off refractive lens. FIG. 4 is a view showing an optical path in which a condenser lens adjusts light distribution asymmetrically left and right in a plane in the lighting device for a vehicle according to another embodiment of the present disclosure. FIG. 5 is a view showing multiple sub-regions emit light with different vertical light distributions in a section of the cut-off refractive lens in the lighting device for a vehicle according to another embodiment of the present disclosure. FIG. 6 is an optical path in which the left and right light amounts are adjusted from an entry surface of the cut-off refractive lens and distributed to an exit surface of the cut-off refractive lens in the lighting device for a vehicle according to another embodiment of the present disclosure. FIG. 7 is a view schematically showing a vertical section of the cut-off refractive lens in the lighting device for a vehicle according to another embodiment of the present disclosure. FIG. 8 is a view showing cross-exiting of light rays in a section of the cut-off refractive lens in the lighting device for a vehicle according to another embodiment of the present disclosure.

Referring to FIGS. 1a, 2a, 3a, 3b, 5, 6, and/or 8, the lighting device for a vehicle of the present disclosure includes a light source 10 and a cut-off refractive lens 30 disposed in front of the light source. The light source 10 is something that emits light and has a predetermined light distribution. The cut-off refractive lens 30 is disposed in front of the light source 10. In this case, the cut-off refractive lens 30 may convert the light emitted from the light source 10 into a symmetric or asymmetric beam and emit the beam. That is, the cut-off refractive lens 30 includes an entry surface 30a that receives light and an exit surface 30b that refracts and emits internal rays 32 that have passed through the entry surface 30a to achieve a set light distribution of a symmetric or asymmetric beam.

Referring to FIGS. 1a, 2a, and/or 3a, the cut-off refractive lens 30 may be constructed by continuing one or more cut-off refractive lens sections 31 formed in a vertical direction. At this time, one or more cut-off refractive lens sections 31 are formed on at least one of a section created by continuing a propagation path of an internal ray 32h on the horizontal plane, which passes through the entry surface 30a and is refracted at the exit surface 30b, in the vertical direction, that is, a vertical extrusion section of the internal ray 32h, and a vertical section independent of the propagation path of the internal ray 32h. Thus, the cut-off refractive lens 30 may be constructed by continuing one or more cut-off refractive lens sections 31 formed on the vertical extrusion section of the internal ray 32h and one or more cut-off refractive lens sections 31 formed on the vertical section independent of the propagation path of the internal ray 32h, by continuing one or more cut-off refractive lens sections 31 formed on the vertical extrusion section of the internal ray 32h, or by continuing one or more cut-off refractive lens sections 31 formed on the vertical section independent of the propagation path of the internal ray 32h. FIG. 3a schematically shows the cut-off refractive lens 30 including the cut-off refractive lens section 31 formed along an internal light path.

The cut-off refractive lens section 31 formed on the vertical section independent of the propagation path of the internal ray 32h may be moved and placed at a predetermined position on the continuous surface forming the cut-off refractive lens 30 in order to realize light exiting at a predetermined left and right angle from the cut-off refractive lens 30.

Meanwhile, referring to FIGS. 1a, 2a, and/or 3a, the cut-off refractive lens section 31 includes an entry surface curve 31a that is an intersection with the entry surface 30a and an exit surface curve 31b that is an intersection with the exit surface 30b. The cut-off refractive lens section 31 satisfies a set vertical light distribution by refracting internal rays 32v that transmitted through the entry surface curve 31a at the exit surface 30b. The exit surface curve 31b refracts the internal rays 32v in the set vertical light distribution and emits the refracted internal rays 32v.

In this case, the entry surface curve 31a is formed so that the internal rays 32v transmitted through the entry surface curve 31a are not totally internally reflected on the exit surface 30b, and the individual internal rays do not upwardly and downwardly cross adjacent internal rays 32v or converge at a point on the exit surface 30b.

In order to form a predetermined left and right light distribution of exit light of the cut-off refractive lens 30, a continuous surface may be formed by gradually moving forward or backward, so as to make continuous, each curve among one or more of the entry surface curves 31a and the exit surface curves 31b in a predetermined cut-off refractive lens section 31 and a continuous adjacent cut-off refractive lens section 31 on a continuous surface forming the cut-off refractive lens 30.

For example, by gradually moving forward or backward, so as to make continuous, the entry surface curve 31a of the cut-off refractive lens section 31 and the adjacent cut-off refractive lens section 31, the left-right incident angle of incident light may be adjusted, and the left and right angle of the internal ray 32h may be changed in the horizontal section of the cut-off refractive lens 30.

In addition, by gradually moving forward or, so as to make continuous, the exit surface curve 31b of the cut-off refractive lens section 31 and the adjacent cut-off refractive lens section 31, a predetermined left and right direction of the light exiting from the cut-off refractive lens section 31 may be formed. For example, referring to FIGS. 1a, 2a, and/or 3a, a plurality of cut-off refractive lens sections 31 may be formed continuously in a cut-off angle conversion zone 30c, and at this time, the exit surface curve 31b of one cut-off refractive lens section 31 and an adjacent cut-off refractive lens section 31 may be gradually moved forward or backward to be continuous to form the exit surface 30b. Although not shown, even in areas other than the cut-off angle conversion zone 30c, the exit surface curve 31b of any cut-off refractive lens section 31 and an adjacent cut-off refractive lens section 31 may be gradually moved forward or backward to be continuous, the entry surface curve 31a of any cut-off refractive lens section 31 and an adjacent cut-off refractive lens section 31 may be gradually moved forward or backward to be continuous, or both the exit and entry surface curves 31b and 31a may be gradually moved forward or backward to be continuous.

For example, continuing the entry surface curve 31a by gradually moving the entry surface curve 31a forward or backward and continuing the exit surface curve 31b by gradually moving the exit surface curve 31b forward or backward in a cut-off refractive lens section 31 and an adjacent cut-off refractive lens section 31 may be performed together.

Referring to FIGS. 1a, 2a, 3a, 3b, and/or 4, in an example, the lighting device for a vehicle may further include a condenser lens 20 between the light source 10 and the cut-off refractive lens 30.

The condenser lens 20 is disposed between the light source 10 and the cut-off refractive lens 30. The condenser lens 20 may distribute light emitted from the light source 10 symmetrically or asymmetrically in the left-right direction or up-down-left-right direction to emit the light in the direction of the cut-off refractive lens 30.

For example, referring to FIG. 4, in an example, the condenser lens 20 collects diffused light from the light source 10 at least in the left-right direction, and may include, in a portion thereof, a luminous flux reduction zone 20c where light is emitted with reduced luminous flux. In FIG. 4, an entry surface 20a of the condenser lens 20 is shown as a straight line in the plan view, and an exit surface 20b of the condenser lens 20 is shown as convex in the plan view. FIG. 4 is one example, and the entry surface 20a of the condenser lens 20 may be formed concave or convex in the plan view, and the exit surface 20b may be formed as a straight line when the entry surface 20a is convex. In addition, although the vertical section is not shown in FIG. 4, at least one of the entry surface 20a and the exit surface 20b may be convex in the vertical section so that light is collected not only in the left and right direction but also in the up and down direction.

For example, the condenser lens 20 may be a separate configuration from the light source 10, or may be formed on the front side of the light source 10 as part of the light source 10, and be either integrally formed inseparably with the light source 10 or mounted to be separable from the light source 10.

In addition, referring to FIG. 5, in an example, the cut-off refractive lens section 31 may be subdivided into one or more sub-regions 31s, and a predetermined vertical light distribution may be assigned to each sub-region 31s. As shown in FIG. 7, the exit surface 30b of the cut-off refractive lens 30 is composed of an upper exit surface 310b and a lower exit surface 330b, and the entry surface 30a of the cut-off refractive lens 30 is composed of an upper entry surface 310a and a lower entry surface 330a so that the cut-off refractive lens section 31 is subdivided into a plurality of sub-regions 31s. FIG. 8 also shows that the exit surface 30b of the cut-off refractive lens 30 is composed of the upper exit surface 310b, a middle exit surface 320b, and the lower exit surface 330b. In this case, the middle exit surface 320b is a focused illumination area Pbr below a cut-off line Pcf, and is a zone on the vertical section where exit light is intensively emitted.

At this time, referring to FIG. 5, one or more corners 30d may be formed on the exit surface 30b of the cut-off refractive lens 30 by continuing the exit surface curves 31b of the cut-off refractive lens sections 31 formed so that any one sub-region 31s and another sub-region 31s adjacent thereto emit light at different vertical angles from a contact point.

Referring to FIG. 5, the uppermost sub-region 31s is a section in which weak light is emitted above the cut-off line, the sub-region 31s in the second from the top is a section in which the emitted rays cross-exit, illustrating that the rays intersect from below the cut-off line to 13 degrees downward (D13), the sub-region 31s in the third from the top is a section in which the light that is emitted from the light source, for example, in a 15 degrees downward (D15) direction, which is a set maximum downward angle, is emitted at the maximum downward angle below the cut-off line to prevent color separation near the maximum downward angle, and the lowermost sub-region 31s is a section in which the light emitted from the light source in a direction further downward than, for example, the set maximum downward angle of 15 degrees downward (D15) is incident and emitted from near the cut-off line to 13 degrees downward (D13).

In FIG. 5, the corner 30d is formed since the exit light is not directed to the same point at the contact point between the top and second sub-regions 31s and at the contact point between the third and bottom sub-regions 31s.

In addition, in FIG. 5, in the case of 15 degrees downward, which is the maximum downward angle of the exit light, the problem of color separation is solved by causing the light emitted at the same angle from the light source 10 to be emitted in a direction of 15 degrees downward, which is the set maximum downward angle.

FIG. 5 is an example, and various other modifications are possible with the concept of FIG. 5.

Alternatively, in another example, naturally continuous sub-regions 31s may be formed on the exit surface 30b of the cut-off refractive lens 30 by continuing the exit surface curves 31b of the cut-off refractive lens sections 31, which are formed as a naturally continuous curve, so that any one sub-region 31s and another adjacent sub-region 31s emit light at the same vertical angle from the contact point. Referring to FIG. 5, at the contact point between the second and third sub-regions 31s from the top, the exit light is emitted to the same point, forming a naturally continuous curve of the exit surface curves 31b.

Next, another example will be explained. In an example, the vertical light distribution of one or more cut-off refractive lens sections 31 constituting the cut-off refractive lens 30 may form cutoff that varies the light and dark at a predetermined vertical angle without a shield. In this case, referring to FIGS. 5 and/or 8, the cut-off refractive lens 30 constructed by continuing the cut-off refractive lens sections 31 may realize the cut-off line. FIGS. 5 and/or 8 shows that the cut-off line is implemented by concentrating the exit light below the cut-off line.

At this time, referring to FIGS. 1a, 2a, and/or 3, the cut-off angle conversion zone 30c, in which the vertical light distribution of the cut-off refractive lens sections 31 is formed to gradually vary up and down cut-off angles so that the cut-off angles gradually change in part of the continuous section of the cut-off refractive lens sections 31, may be formed in the cut-off refractive lens 30. In FIGS. 1b and/or 2b, it is shown that the cut-off angle changes upward to the right at the beginning of the shoulder portion.

For example, referring to FIGS. 1a, 2a, and/or 3, the cut-off angle conversion zone 30c may be formed in the middle portion of the cut-off refractive lens 30, or, although not shown, in another example, may be formed in an outer portion outside the middle portion of the cut-off refractive lens 30.

Although not shown, the cut-off angle conversion zone 30c may be formed, for example, only in a section formed by a specific continuation of the sub-region 31s, rather than in the entire portion of the part of the continuous section of the cut-off refractive lens sections 31.

For example, referring to FIG. 8, in order to prevent or minimize color separation at the cut-off line, the cut-off refractive lens 30 may focus the light from the optical axis or the center close to the optical axis of the light source 10 to the bright area of the cut-off line. In FIG. 8, it is shown that the exit light emitted from a middle exit surface 320b is focused on the bright area (focused illumination area) Pbr below the cut-off line. FIG. 8 also shows that the exit light from a section (upper area) of the upper exit surface 310b of the exit surface 30b is emitted to a set maximum downward angle point Plow while the exit light from a section (lower area) of the lower exit surface 330b of the exit surface 30b is emitted to the same set maximum downward angle point Plow, and the color-separated lights are combined complementarily to solve the color separation problem.

For example, in FIG. 5, referring to the light emitted from the bottom of the third sub-region 31s from the top, to prevent color separation from occurring at the maximum downward angle of the set vertical light distribution, light exiting from the light source 10 at the same angle as the maximum downward angle may be emitted from the cut-off refractive lens 30 at the set maximum downward angle.

For example, referring to FIG. 8, light may be emitted at the maximum downward angle of the set vertical light distribution at a specific point on the vertical section of the upper part of the exit surface 30b of the cut-off refractive lens 30, for example, a specific point in the upper area in FIG. 8, and light may be emitted at the maximum downward angle at a specific point on the vertical section of the lower part of the exit surface 30b, for example, a specific point in the lower area in FIG. 8. At this time, the light emitted from the specific point on the upper part of the exit surface 30b is separated into red above and blue below, with yellow as the center, and the light emitted from the specific point on the lower part of the exit surface 30b is separated into blue above and red below, with yellow as the center, but since the color separation widths of the lights emitted from the respective specific points on the upper and lower parts of the exit surface 30b are similar to each other, color separation may be eliminated.

Meanwhile, although not shown, the cut-off refractive lens 30 may be formed in a portion of any lens, and in this case, the remaining portion is not the cut-off refractive lens 30 of the present disclosure. The condenser lens 20 may also be formed in a portion of any lens, and in this case, the remaining portion is not the condenser lens 20 of the present disclosure. For example, a portion of a composite lens formed as one piece, for example, the middle portion, may be configured as the cut-off refractive lens 30, and the outer portion may be configured as an auxiliary lens, or a portion of a composite lens formed as one piece, for example, the middle portion, may be configured as the condenser lens 20, and the outer portion may be configured as an auxiliary lens, but is not limited thereto.

The light source 10 may be understood as any form that emits light, and includes those in which a lens is integrated into a light emitting part or in which a lens is added separately.

In the case where a lens is integrated into the light emitting part or a lens is added separately, the light source 10 includes a form in which light is concentrated symmetrically or asymmetrically in the left-right and up-down directions, compared to general LEDs and laser diodes with light distribution that follows the law of cosines, and in this case, the function of the condenser lens 20 may be realized in the light source 10.

Meanwhile, the light source 10 in the form of a general LED or a laser diode that follows the law of cosines emits diffused light in a hemispherical shape with distribution approximate to the ratio of cosine (0 degrees)=1 at the optical axis, cosine (60 degrees)=½ at 60 degrees on one side, and cosine (90)=0 at 90 degrees on one side.

Referring to FIGS. 3b and/or 4, the condenser lens 20 may emit the light exiting from the light source 10 onto the entry surface 30a of the cut-off refractive lens 30 by distributing the light symmetrically or asymmetrically when viewed from a plane, that is, in the left-right direction. Although not shown, the condenser lens 20 may distribute the light symmetrically or asymmetrically not only in the left and right direction but also in the up and down direction to emit the light onto the entry surface 30a of the cut-off refractive lens 30.

For example, because the condenser lens 20 does not need to collect light in the up and down direction depending on the embodiment, the performance of the cut-off refractive lens is such that the image of the light source is created to be smaller in the cut-off refractive lens 30 in proportion to the distance from the light source 10, and thus the cut-off refractive lens 30 may realize a relatively precise cut-off line, and may be little affected by the distance between the condenser lens 20 and the light source 10.

In addition, when the lighting device for a vehicle realizes an asymmetric beam, precise production of the cut-off angle conversion zone 30c may be difficult for the cut-off angle conversion zone 30c that realizes a change in the cut-off line in which the shoulder section, which gradually rises in either left or right direction, does not rise gently at about 15 degrees, but moves only about 1.5 degrees to the left or right, sharply rises at about 45 degrees, and then again becomes parallel to the horizontal line.

For example, according to an example shown in FIG. 1a or FIG. 2a, when the distance of the cut-off refractive lens 30 to the light source 10 (distance from the outer starting point of the entry surface to the light source) is 18 mm, the left and right width of the cut-off angle conversion zone 30c was only about 1.2 mm (d2), and this may result in significant costs for mold processing. Thus, it is necessary to expand the width of the cut-off angle conversion zone 30c to alleviate this problem.

Therefore, referring to FIGS. 1a, 2a, and/or 3a, the condenser lens 20 may include the luminous flux reduction zone 20c in which the luminous flux, that is, the density of rays, of the light emitted from the light source 10 is small in a predetermined angle range and emitted to an entry surface 30ca of the cut-off angle conversion zone. At this time, as for the entry surface 30ca of the cut-off angle conversion zone, the entry and exit surfaces of the cut-off refractive lens 30 may be formed by creating a plurality of cut-off refractive lens sections 31 that realize top-down cut-off angles corresponding to the predicted left-right angle values of the exit light, and using a continuous surface of the created cut-off refractive lens sections 31.

Referring to FIG. 4, when the condenser lens 20 collects light when viewed from a plane but includes the luminous flux reduction zone 20c, by making the luminous flux reduction zone 20c correspond to the cut-off angle conversion zone 30c of the cut-off refractive lens 30, and emitting light with luminous flux reduced in the luminous flux reduction zone 20c, side effects according to the principle of image in the cut-off angle conversion zone 30c may be reduced and processing may be facilitated.

FIG. 4 is a top view of the condenser lens 20 for realizing an asymmetric beam, including the luminous flux reduction zone 20c. In FIG. 4, the light path from L0.62 degrees to R1.53 degrees is formed smaller than other light paths, and the cut-off refractive lens 30 may be allocated to a narrow area where the cut-off angle moves 1.5 degrees to the right and 1.5 degrees upward, then becomes parallel to the horizontal line, i.e., 45 degrees upward to the right in receiving and emitting the exit light with luminous flux reduced in the luminous flux reduction zone 20c.

Both symmetric and asymmetric beams are spread in the left and right direction, and thus it is not a problem even if the image of the light source 10 is expanded to the left and right. The condenser lens 20 may collect the light from the light source 10 at any intensity in the left and right direction, and depending on the degree of light collection of the condenser lens 20 in the left and right direction, the left and right width of the cut-off refractive lens 30 may be formed very narrow, and by placing the small size condenser lens 20 right in front of the light source 10, light from the light source 10 may be efficiently collected. As a result, it is possible to efficiently utilize the light from the light source 10 without the auxiliary reflector or auxiliary lens part proposed in U.S. Pat. No. 2,419,832. As an example, the condenser lens 20 may be configured separately from the light source 10, or even when configured as a part of the light source 10, the condenser lens 20 may be provided as an inseparable piece with the light source 10 or may be provided as a separable attachment to the light source.

Therefore, it would be sufficient for the condenser lens 20 in the present disclosure to have a light condensing or distribution function in the left and right direction, and light condensing in other directions is not required. Adding a light condensing function in the up and down direction belongs to an application embodiment.

That is, it is not excluded to add a function of collecting the emitted light from the light source 10 in the vertical direction and emitting the collected light to the entry surface 30a of the cut-off refractive lens 30.

In addition, when adding a light condensing function in the vertical direction to the condenser lens 20 to condense light close to parallel light in the vertical direction as well, a precise cut-off line may be realized in proportion to the distance between the light source 10 and the condenser lens 20. In this case, a method of condensing close to parallel light from only one of the upper and lower sides is also possible.

As an embodiment, the portion above the horizontal plane of the condenser lens 20 is set to emit rays condensed as parallel light when viewed from the side, thereby reducing the size of the upper part of the cut-off refractive lens 30, and when the portion below the horizontal plane of the condenser lens 20 emits rays that are not condensed when viewed from the side to the lower part of the cut-off refractive lens 30, the emitted light from the lower part of the cut-off refractive lens 30 realizes a sharp cut-off line.

For example, depending on the embodiment, since a lens that condenses parallel light when viewed from the side may not be used, only a weak condensation intensity may be used, or the condenser lens 20 that condenses parallel light on the upper side thereof but does not condense parallel light on the lower side thereof may be used, even in the vertical direction, the light rays at the maximum downward angle (e.g., an arbitrary setting angle of about D4° to about D15°) of a light source, which do not undergo color separation from the beginning, may be emitted at the maximum downward angle through the cut-off refractive lens 30, while creating a sharp cut-off line by focusing the light without color separation of an optical axis on the cut-off line, eliminating the problem of color separation. There is also no color separation problem in the left and right direction since the diffused light from the light source is diffused to the left and right in a similar width.

In this respect, rather than explaining the exit surface or entry surface of the condenser lens 20 as a convex or concave <shape>, by explaining the <function>, a person with ordinary knowledge in the relevant technical field can sufficiently and clearly understand the scope.

The cut-off refractive lens 30 includes the entry surface 30a that receives the light exiting from the condenser lens 20 or the light exiting from the light source 10, and the exit surface 30b that refracts and emits the internal rays 32 that have passed through the entry surface 30a. In this case, the cut-off refractive lens 30 may be formed by continuing one or more cut-off refractive lens sections 31. That is, the entry surface 30a of the cut-off refractive lens 30 is formed as a continuous surface of the entry surface curves of the cut-off refractive lens sections 31, and the exit surface 30b is formed as a continuous surface of the exit surface curves 31b of the cut-off refractive lens sections 31.

Referring to FIGS. 4, 5, and/or 8, depending on the embodiment, the condenser lens 20 may be omitted, or the condenser lens 20 refracts only a portion of the exit light from the light source 10 and emits the refracted light to the cut-off refractive lens 30, and the light source 10 may directly emit some of the exit light to the cut-off refractive lens 30.

In addition, the entry surface 30a of the cut-off refractive lens 30 may, when viewed from a plan view, distribute the light so that the internal ray 32h exits the exit surface 30b of the cut-off refractive lens 30 symmetrically or asymmetrically.

For example, when the condenser lens 20 converges light narrower than a target left-right diffusion angle in the left and right direction on a plane, a left-right diffusion surface may be added to the entry surface of the cut-off refractive lens 30 in a similar manner to that proposed in U.S. Pat. No. 2,419,832. The target left-right diffuse light distribution may also be achieved by forming the exit surface of the cut-off refractive lens 30 to be concave when viewed from a plane.

FIG. 6 is an example of a plan view in which the entry surface 30a of the cut-off refractive lens 30 asymmetrically distributes the left and right light amounts to the exit surface 30b of the cut-off refractive lens 30 without the condenser lens 20.

The cut-off refractive lens section 31 is created on the vertical extrusion plane of a randomly selected internal ray 32h, and the left-right direction angle of the exit light may be predicted according to Snell's law by using the left-right direction angle of the internal ray 32h, the angle of a straight line connecting the intersection of the exit surface curve 31b of a cut-off refractive lens section 31 with the horizontal plane and the intersection of the exit surface curve 31b of an adjacent cut-off refractive lens section 31 with the horizontal plane, and the refractive index of the cut-off refractive lens 30 depending on the medium as variables. In this case, by gradually moving the exit surface curve 31b of the adjacent cut-off refractive lens section 31 forward or backward, the left-right direction angle of the light emitted from the cut-off refractive lens section 31 may be adjusted, and by moving the entry surface curve 31a of the adjacent cut-off refractive lens section 31 of the cut-off refractive lens section 31 forward or backward to be continuous to change the left-right angle of the internal ray 32h, the left-right angle of the exit light at the cut-off refractive lens section 31 may also be changed.

In this way, the exit surface 30b of the cut-off refractive lens 30 may be freely transformed to be convex or concave when viewed from a plane, thereby distributing the exit light symmetrically or asymmetrically in the left and right direction. Furthermore, the cut-off refractive lens section 31 may realize light distribution in the vertical direction while forming a cut-off line without color separation with respect to the predicted left-right direction angle of the exit light without a shield.

In addition, the cut-off refractive lens sections 31, which realize assigned light distribution in the vertical direction for each predetermined left-right angle are created in a vertical plane, rather than on the vertical protrusion plane of the internal light ray 32, and distributed and arranged in positions expected to realize assigned exit light of the left-right direction angle, and with the entry surface 30a and the exit surface 30b of the cut-off refractive lens created by continuing the cut-off refractive lens sections 31, the cut-off refractive lens 30 may be constructed.

In practice, in an area where the cut-off line is level, calculation of the left-right direction angle is virtually unnecessary because it would be sufficient to achieve sufficient diffusion width beyond that required by law. In addition, in the cut-off angle conversion zone 30c where the cut-off angle changes, because the left-right change range of the angle is narrow, it would be sufficient to precisely arrange the cut-off refractive lens sections 31 for individual left-right angles, but arbitrarily form a plurality of cut-off refractive lens sections 31 and construct the cut-off refractive lens 30 by forming the plurality of cut-off refractive lens sections 31 in succession.

The cut-off angle conversion zone 30c shown in FIG. 1a or FIG. 2a is formed by this simplified method, and the light distribution diagram in FIG. 1b or FIG. 2b shows that a satisfactory cut-off angle change has been realized.

That is, FIG. 1a is an example in which a number of cut-off refractive lens sections are created on the vertical plane and intensively disposed in the cut-off angle conversion zone 30c, to the left, one cut-off refractive lens section 31 forming a cut-off line below the horizontal line protrudes while to the right, one cut-off refractive lens section 31 forming a cut-off line above the horizontal line protrudes, and in the cut-off angle conversion zone, a number of cut-off refractive lens sections 31 with gradually increasing cut-off angles are intensively disposed. Despite the simple protrusion, the horizontal area of the light distribution diagram in FIG. 1b is only slightly tilted outward, and a sharp cut-off line is formed in the characteristic curve of luminous intensity (Iv) in L1.5.

FIG. 2a is an example in which the left part of the cut-off refractive lens 30 is corrected by adding the cut-off refractive lens section 31 to the left side of the cut-off refractive lens 30, corrected by slightly upward tilting of the left part, which is not parallel to the horizontal line but tilted downward in the light distribution diagram in FIG. 1b, and continuing the corrected cut-off refractive lens section 31 with the existing cut-off refractive lens sections 31. In the light distribution diagram in FIG. 2b, the horizontality of the vertical scanning areas (L1.5, L2.5, L3.5 according to ECE R112 Annex 9) that verify the quality of the cut-off line was corrected, and a sharp cut-off line is formed in the characteristic curve of luminous intensity (Iv) in L1.5.

FIG. 2c is an example of creating a cut-off refractive lens section 31 on the vertical protrusion plane of the internal ray, resulting in a result similar to FIG. 2a.

FIG. 3a is an example in which the left area in the drawings of FIGS. 1a to 2a is corrected for the horizontal area by additionally creating a cut-off refractive lens section 31 matching the internal ray 31h.

Depending on the embodiment, in the present disclosure, it is not required that the cut-off refractive lens section 31 necessarily coincides with the vertical protrusion plane of the internal ray 32 projected on the horizontal plane, and by creating a number of cut-off refractive lens sections 31 that satisfy the vertical light distribution required for each left/right (L/R) angle only in sections where the cut-off angle changes depending on the L/R angle or the vertical light distribution changes rapidly, placing these cut-off refractive lens sections 31 at predetermined positions to form the cut-off refractive lens 30 where exit light at a predetermined L/R angle is expected, and continuing these cut-off refractive lens sections 31 to form the cut-off angle conversion zone 30c of the cut-off refractive lens 30, and for the cut-off refractive lens 30 in the part where the cut-off angle does not change, the cut-off refractive lens 30 may be formed by creating only one cut-off refractive lens section 31 that realizes a predetermined cut-off angle, or by adding a cut-off refractive lens section 31 with the cut-off angle corrected afterwards and continuing the cut-off refractive lens section 31.

In addition, since the exit angle may be adjusted in the left and right direction by adjusting the exit surface curve 31b of the cut-off refractive lens sections 31 forming the cut-off angle conversion zone 30c forward or backward, unlike in FIG. 1a or FIG. 2a, which is an embodiment, the cut-off angle conversion zone 30c may be placed at an arbitrary location on the outside.

Regarding the entry surface curve provided on the cut-off refractive lens section 31, the entry surface curve needs to be created such that the internal rays 32v that have passed through the entry surface curve are not totally internally reflected on the exit surface 30b of the cut-off refractive lens 30, and regarding the internal rays 32 generated by assuming that the light source 10 is an ideal point light source 10, the internal ray 32 that passes through any point of the entry surface curve 31a and the internal ray 32 that passes through the point below the above point should not have any upper or lower intersections when reaching the exit surface curve 31b. The part that does not satisfy these conditions does not correspond to the part that functions as the cut-off refractive lens of the present disclosure.

Therefore, as long as the above conditions are met, the entry surface curve 31a of the cut-off refractive lens 30 may be a natural curved surface or an arbitrary surface including multiple edges or steps.

By dividing the exit surface curve 31b and the entry surface curve 31a of the “cut-off refractive lens section 31” into one or more “sub-regions 31s” and assigning light distribution of a predetermined vertical angle range to each sub-region 31s, “exit surface curves 31sb belonging to upper and lower sub-regions 31s adjacent to each other and corresponding entry surface curves 31sa” may be formed continuously or discontinuously.

Therefore, the cut-off angle conversion zone 30c may also be assigned to one or more sub-regions 31s that are part of the cut-off refractive lens section 31c shown in FIG. 5, unlike in FIG. 1a or FIG. 2a, which is an embodiment.

At this time, referring to FIG. 5, the exit lights from the “sub-regions 31s” may be “cross exited vertically” at a direction angle where the up-down exit angle at a certain point is lower than the up-down exit angle at a lower point than the certain point, or conversely, the exit lights from the “sub-regions 31s” may be “sequentially exited vertically” at a direction angle where the up-down exit angle at a certain point is higher than the up-down exit angle at a lower point than the certain point. At this time, when the exit lights are exited at the same vertical angle at the contact point of two adjacent “sub-regions 31s”, the two “sub-regions 31s” become tangentially continuous with each other. Otherwise, the contact point forms a discontinuous vertex, and the exit surface 30b of the cut-off refractive lens 30, which is formed by continuing the sub-regions 31s, becomes cornered between the sub-regions 31s.

FIG. 5 is an example in which the sub-regions are divided into four sections, that is, A (top), B (second), C (third), and D (bottom), and the ray paths that were tangentially continuous with each other were realized in B and C, the ray paths were set to cross up and down in C, and in A and B, and in C and D are cornered at the point of contact.

Depending on the embodiment, color separation may not occur from the beginning, or color separation may be eliminated, not only at the cut-off line but also at the maximum downward angle.

For example, referring to FIG. 5, when the maximum downward angle desired for vertical light distribution is, for example, D15, it would be sufficient that a sub-region 31s is created so that the path of ray exiting from the light source at D15 is emitted at the maximum downward angle D15, and for other sub-regions 31s, the up and down range of the exit angle is set to be higher than the maximum downward angle.

In this case, there is no need to explain why color separation does not occur because little color separation occurs in the vertical direction along the path of light ray that passes from the light source 10 through the condenser lens 20 and through the cut-off refractive lens 30, or the original exit angle is restored during the vertical refraction process, and the same is true in the left and right direction.

Next, referring to FIG. 8, color separation may be eliminated by arbitrarily designating points at the top and bottom where absolute values of the cumulative refraction angles of the upper and lower exit ray paths or the widths of color separation are similar, and allocating the exit light at the maximum downward angle at those points.

As an example, in FIG. 5 (B) (second), when the light ray coming from the light source 10 upwards at U15 degrees is refracted at D15 at the top of the cut-off refractive lens 30, it is equivalent to cumulative refraction of 30 degrees in the D direction, and in (D) (bottom), when the light ray coming from the light source 10 downwards at D45 degrees is refracted at D15 at the bottom of the cut-off refractive lens 30, it is equivalent to cumulative refraction of 30 degrees in the U direction. Thus, when two light ray paths are combined at the maximum downward angle, the ray emitted from the top at the maximum downward angle is separated into red above and blue below, with yellow as the center, and the ray emitted from the bottom at the maximum downward angle is separated into blue above and red below, with yellow as the center, but since the cumulative refraction angles or color separation widths of the two light ray paths is almost the same, color separation may be eliminated.

In (B) (second) and (D) (bottom) of FIG. 5, the maximum downward angle is set to D13 to offset the color separation, and (C) (third) is an example in which the maximum downward angle is set to D15, and the ray emitted from the light source to D15 is emitted to D15, and the ray without color separation is emitted to D15.

The entry surface of the cut-off refractive lens 30 may distribute the light amount symmetrically or asymmetrically to the exit surface of the cut-off refractive lens with or without the condenser lens 20 when viewed from a plane. Accordingly, the present disclosure may be implemented without the condenser lens 20.

Another example will be described. In an example, by disposing the condenser lens 20 between the light source 10 and the cut-off refractive lens 30, the light exiting from the light source 10 may be distributed symmetrically or asymmetrically in the up-down-left-right direction, and be emitted in the direction of the cut-off refractive lens 30. Alternatively, although not shown, a vertical refractive lens (not shown) may be additionally placed between the light source 10 and the cut-off refractive lens 30 so that the light exiting from the light source 10 may be emitted as parallel light or close to the parallel light when viewed from the side. When additionally arranging the vertical refractive lens, the vertical refractive lens may be placed without the condenser lens 20 or may be placed in front or behind the condenser lens 20.

At this time, although not shown, in an example, the lighting device may further include a reflector and one or more auxiliary lenses. For example, the reflector may reflect light deviating from the condenser lens 20 or the vertical refractive lens into parallel light or close to the parallel light when viewed from the side as the condenser lens 20 or the vertical refractive lens moves away from the light source 10.

One or more auxiliary lenses are formed on the outside of the cut-off refractive lens 30, or on the outside of the condenser lens 20 or the vertical refractive lens, and may refract, diffuse, or refract and diffuse the light reflected from the reflector in a set direction.

In the above, the above-described embodiment(s) and/or the attached drawing(s) are described as examples to aid the understanding of those skilled in the art regarding the present disclosure. Various embodiments of the present disclosure may be implemented in various modified forms according to various combinations of the above-described components without departing from the essential characteristics of the present disclosure, and may also be implemented in a form with new components added. Therefore, the scope of the present disclosure should be construed to include not only the above-described embodiments but also various modifications, alternatives, and equivalent embodiments by those skilled in the art.

### INDUSTRIAL APPLICABILITY

The present disclosure relates to a lighting device for a vehicle, and may be widely used in industrial fields related to vehicle lighting, as well as applicable to other fields of lighting technology.

1. A lighting device for a vehicle, the device comprising:
a light source (10); and
a cut-off refractive lens (30) disposed in front of the light source (10),
wherein the cut-off refractive lens (30) is configured to include an entry surface (30a) that receives light and an exit surface (30b) that refracts internal rays (32) that have passed through the entry surface (30a) and emits the refracted internal rays (32), and to realize a set light distribution of a symmetrical or asymmetrical beam,
the cut-off refractive lens (30) is constructed by continuously forming one or more cut-off refractive lens sections (31) in a vertical direction, and the one or more cut-off refractive lens sections (31) are formed on at least one of a section created by continuing a propagation path of an internal ray (32h) on a horizontal plane, which passes through the entry surface (30a) and is refracted at the exit surface (30b), in the vertical direction, and a vertical section independent of the propagation path of the internal ray (32h),
any cut-off refractive lens section (31), among the one or more cut-off refractive lens sections (31), formed on the vertical section independent of the propagation path of the internal ray (32h) is moved and placed at predetermined position on a continuous surface forming the cut-off refractive lens (30) in order to realize light exiting at a predetermined left and right angle from the cut-off refractive lens (30),
each of the one or more cut-off refractive lens sections (31) includes an entry surface curve (31a) that is an intersection with the entry surface (30a) and an exit surface curve (31b) that is an intersection with the exit surface (30b),
the one or more cut-off refractive lens sections (31) satisfy a set vertical light distribution by refracting internal rays (32v) that transmitted through the entry surface curve (31a) at the exit surface (30b),
the entry surface curve (31a) of the each of the one or more cut-off refractive lens sections (31) is formed so that the internal rays (32v) transmitted through the entry surface curve (31a) are not totally internally reflected on the exit surface (30b), and the individual internal rays (32v) do not upwardly and downwardly cross adjacent internal rays (32v) or converge at a point on the exit surface (30b), and
in order to form a predetermined left and right light distribution of exit light of the cut-off refractive lens (30), a continuous surface is formed by gradually moving forward or backward, so as to make continuous, each curve of any one or more among the entry surface curves (31a) and exit surface curves (31b) at a predetermined cut-off refractive lens section (31) and a continuous adjacent cut-off refractive lens section (31) among the one or more cut-off refractive lens sections (31) on the continuous surface forming the cut-off refractive lens (30).

2. The lighting device of claim 1, wherein a left and right angle of the internal ray (32h) is changed in a horizontal section of the cut-off refractive lens (30) by adjusting a left-right incident angle of incident light by gradually moving forward or backward, so as to make continuous, the entry surface curve (31a) of a cut-off refractive lens section (31) and an adjacent cut-off refractive lens section (31) among the one or more cut-off refractive lens sections (31).

3. The lighting device of claim 1, wherein a predetermined left and right direction of light exiting from the cut-off refractive lens sections (31) is formed by gradually moving forward or backward, so as to make continuous, the exit surface curve (31b) of a cut-off refractive lens section (31) and an adjacent cut-off refractive lens section (31) among the one or more cut-off refractive lens sections (31).

4. The lighting device of claim 1, further comprising:
a condenser lens (20) disposed between the light source (10) and the cut-off refractive lens (30), and configured to distribute light emitted from the light source (10) symmetrically or asymmetrically in a left-right direction or up-down-left-right direction to emit the light in a direction of the cut-off refractive lens (30).

5. The lighting device of claim 4, wherein in a portion of the condenser lens (20), a luminous flux reduction zone (20c) where light is emitted with reduced luminous flux is included.

6. The lighting device of claim 4, wherein the condenser lens (20) may be a separate configuration from the light source (10), or may be formed on a front side of the light source (10) as part of the light source (10), and be either integrally formed inseparably with the light source (10) or mounted to be separable from the light source (10).

7. The lighting device of claim 1, wherein each of the cut-off refractive lens sections (31) is subdivided into one or more sub-regions (31s), and a predetermined vertical light distribution is assigned to each sub-region (31s).

8. The lighting device of claim 7, wherein one or more corners are formed on the exit surface (30b) of the cut-off refractive lens (30) by continuing the exit surface curves (31b) of the cut-off refractive lens sections (31) formed so that one or more sub-regions (31s) and other sub-regions (31s) adjacent thereto emit light at different vertical angles from contact points.

9. The lighting device of claim 7, wherein naturally continuous sub-regions (31s) are formed on the exit surface (30b) of the cut-off refractive lens (30) by continuing the exit surface curves (31b) of the cut-off refractive lens sections (31), which are formed as a naturally continuous curve so that any one sub-region (31s) and another sub-region (31s) adjacent thereto emit light at a same vertical angle from a contact point.

10. The lighting device of claim 1, wherein vertical light distribution of the one or more cut-off refractive lens sections (31) constituting the cut-off refractive lens (30) forms cutoff that varies light and dark at a predetermined vertical angle without a shield, and the cut-off refractive lens (30) constructed by continuing the cut-off refractive lens sections (31) realizes a cut-off line.

11. The lighting device of claim 10, wherein a cut-off angle conversion zone (30c), in which the vertical light distribution of the cut-off refractive lens sections (31) is formed to gradually vary up and down cut-off angles so that the cut-off angles gradually change in part of a continuous section of the cut-off refractive lens sections (31), is formed in the cut-off refractive lens (30).

12. The lighting device of claim 10, wherein in order to prevent or minimize color separation at the cut-off line, the cut-off refractive lens (30) focuses light from an optical axis or a center close to the optical axis of the light source (10) to a bright area of the cut-off line.

13. The lighting device of claim 10, wherein in order to prevent color separation from occurring at a maximum downward angle of a set vertical light distribution, light exiting from the light source (10) at a same angle as the maximum downward angle is emitted from the cut-off refractive lens (30) at a set maximum downward angle.

14. The lighting device of claim 10, wherein light is emitted at a maximum downward angle of a set vertical light distribution at a specific point on a vertical section of an upper part of the exit surface (30b) of the cut-off refractive lens (30), and light is emitted at the maximum downward angle at a specific point on a vertical section of a lower part of the exit surface (30b), wherein the light emitted from the specific point on the upper part of the exit surface (30b) is separated into red above and blue below, with yellow as a center, and the light emitted from the specific point on the lower part of the exit surface (30b) is separated into blue above and red below, with yellow as a center, and since color separation widths of the lights emitted from the respective specific points on the upper and lower parts of the exit surface (30b) are similar to each other, color separation is eliminated.

15. The lighting device of claim 10, wherein, by disposing the condenser lens (20) between the light source (10) and the cut-off refractive lens (30), light exiting from the light source (10) is distributed symmetrically or asymmetrically in the up-down-left-right direction, and emitted in a direction of the cut-off refractive lens (30), or by additionally placing a vertical refractive lens between the light source (10) and the cut-off refractive lens (30), the light exiting from the light source (10) is emitted as parallel light or close to the parallel light when viewed from a side.

16. The lighting device of claim 15, further comprising:
a reflector configured to reflect light deviating from the condenser lens (20) or a vertical refractive lens into parallel light or close to the parallel light when viewed from a side as the condenser lens (20) or the vertical refractive lens moves away from the light source (10); and
one or more auxiliary lenses formed on an outside of the cut-off refractive lens (30), or on an outside of the condenser lens (20) or the vertical refractive lens, configured to refract, diffuse, or refract and diffuse the light reflected from the reflector in a set direction.

17. The lighting device of claim 2, wherein vertical light distribution of the one or more cut-off refractive lens sections (31) constituting the cut-off refractive lens (30) forms cutoff that varies light and dark at a predetermined vertical angle without a shield, and the cut-off refractive lens (30) constructed by continuing the cut-off refractive lens sections (31) realizes a cut-off line.

18. The lighting device of claim 3, wherein vertical light distribution of the one or more cut-off refractive lens sections (31) constituting the cut-off refractive lens (30) forms cutoff that varies light and dark at a predetermined vertical angle without a shield, and the cut-off refractive lens (30) constructed by continuing the cut-off refractive lens sections (31) realizes a cut-off line.

19. The lighting device of claim 4, wherein vertical light distribution of the one or more cut-off refractive lens sections (31) constituting the cut-off refractive lens (30) forms cutoff that varies light and dark at a predetermined vertical angle without a shield, and the cut-off refractive lens (30) constructed by continuing the cut-off refractive lens sections (31) realizes a cut-off line.

20. The lighting device of claim 5, wherein vertical light distribution of the one or more cut-off refractive lens sections (31) constituting the cut-off refractive lens (30) forms cutoff that varies light and dark at a predetermined vertical angle without a shield, and the cut-off refractive lens (30) constructed by continuing the cut-off refractive lens sections (31) realizes a cut-off line.
